(19) United States
(12) Patent Application Publication
(10) Pub. No.: US 2009/0026851 A1
(43) Pub. Date: Jan. 29, 2009

(54) MOTOR ARMATURE AND METHOD OF MANUFACTURING SAME

(76) Inventor: DEAN-RANG LIOU, Taichung (TW)

Correspondence Address: G. LINK CO., LTD., 3550 BELL ROAD, MINOOKA, IL, 60447, US

(21) Appl. No.: 11/782,132

(22) Filed: Jul. 24, 2007

(51) Int. Cl. H02K 15/02; H02K 1/28

(52) U.S. Cl. 310/42; 29/598; 310/264

(57) ABSTRACT

A motor armature includes radially projecting laminations having T-shaped electrical steel strips including recesses on a front surface of its short part, and projections on a rear surface of the short part aligned with the recesses wherein each of the two outermost electrical steel strips further has an arcuate first through hole proximate either side; and a plurality of front and rear interconnection groups comprising first, second, and third interconnections wherein each of the first and the second interconnections includes two cavities on a front surface and two protrusions on a rear surface aligned with the cavities, and the third interconnection includes two second through holes, two arcuate left and right grooves on a front surface and two protuberances on a rear surface aligned with the grooves. A method of manufacturing the motor armature is also disclosed.

### BACKGROUND OF THE INVENTION

1. Field of Invention

The invention relates to electric motors and more particularly to an improved armature of an electric motor and method of manufacturing same.

2. Description of Related Art

A conventional armature of an electric motor comprises a plurality of electrical steel strips laminated together. The electrical steel strips are shaped as a plurality of radially projecting lamination posts of T. Coils are wound on the electrical steel strips to form a motor stator.

However, the winding is disadvantageous because the shapes of the posts hinder the winding. It is typically that the winding is uneven, resulting in a lowering of motor torque output. Thus, a need for improvement exists.

### SUMMARY OF THE INVENTION

It is therefore one object of the invention to provide an armature of an electric motor, comprising a plurality of radially projecting laminations having a plurality of T-shaped electrical steel strips including a plurality of recesses on a front surface of its short part, and a plurality of projections on a rear surface of the short part aligned with the recesses wherein each of the two outermost electrical steel strips further has an arcuate first through hole proximate either side; and a plurality of front and rear interconnection groups comprising first, second, and third interconnections wherein each of the first and the second interconnections comprises two transversely spaced cavities on a front surface and two protrusions on a rear surface aligned with the cavities, and the third interconnection includes two transversely spaced second through holes, two arcuate grooves each proximate either right or left side on a front surface, and two protuberances on a rear surface aligned with the grooves, whereby (a) inserting the recesses of one electrical steel strip into the projections of the other electrical steel strip therebehind will secure the electrical steel strips together and assemble a lamination by repeating the insertion; (b) inserting the protrusions of the first interconnection into the cavities of the second interconnection and inserting the protrusions of the second interconnection into the second through holes of the third interconnection will assemble an interconnection group; (c) inserting the protuberances of the third interconnection of one interconnection group into the first through holes of the two outermost electrical steel strips of one lamination and into the first through holes of the two outermost electrical steel strips of an adjacent lamination respectively will assemble one interconnection group and the two adjacent laminations together; (d) repeating (c) will assemble a first half-finished armature; (e) winding coils on the first half-finished armature will assemble a second half-finished armature; and (f) folding the second half-finished armature will assemble the finished armature.

It is another object of the invention to provide a method of manufacturing an armature of an electric motor, comprising the steps of (a) feeding an elongated strip of electrical steel sheet material; (b) punching the elongated strip of electrical steel sheet material into a plurality of circular pieces of electrical steel; (c) cutting the circular pieces of electrical steel into a plurality of individual T-shaped electrical steel strips; (d) assembling the electrical steel strips with a plurality of interconnections to produce a first half-finished armature; (e) unfolding the first half-finished armature; (f) winding coils on the electrical steel strips; (g) folding the electrical steel strips to form a second half-finished armature; and (h) soldering joining portions of the second half-finished armature to produce the finished armature.

The above and other objects, features and advantages of the invention will become apparent from the following detailed description taken with the accompanying drawings.

### BRIEF DESCRIPTION OF THE DRAWINGS

FIG. 1 is a perspective view of an exemplary armature of an electric motor constructed according to the invention;

FIG. 2 is an exploded perspective view of a portion of the armature;

FIG. 3 is a front view of a portion of the armature of FIG. 2;

FIG. 4 is a view similar to FIG. 3 where the connected electrical steel strips are arranged horizontally by pivotably unfolding;

FIG. 5 is a sectional view taken along line 5-5 of FIG. 3;

FIG. 6 is a perspective view of a plurality of connected electrical steel strips arranged linearly as a half-finished product;

FIG. 7 is a perspective view of a circular piece of electrical steel strips formed by punching a sheet metal;

FIG. 8 is a perspective view of the electrical steel strips of FIG. 6 being folded as track in the process of forming an armature;

FIG. 9 is a view similar to FIG. 8 where the electrical steel strips have been folded to form a circular armature; and

FIG. 10 is a flowchart depicting a process for manufacturing an armature according to the invention.

### DETAILED DESCRIPTION OF THE INVENTION

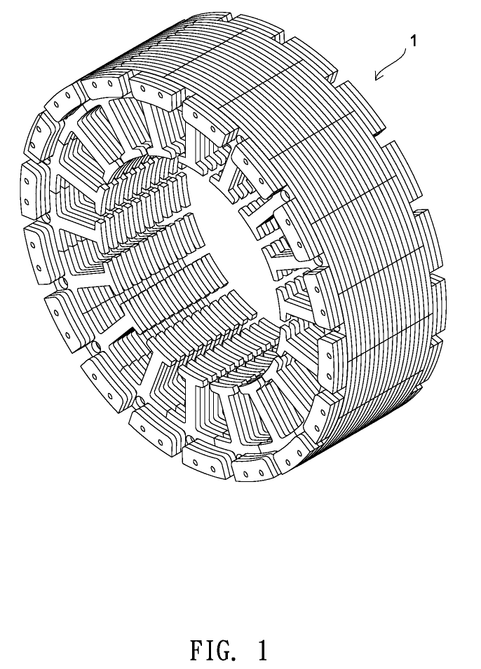

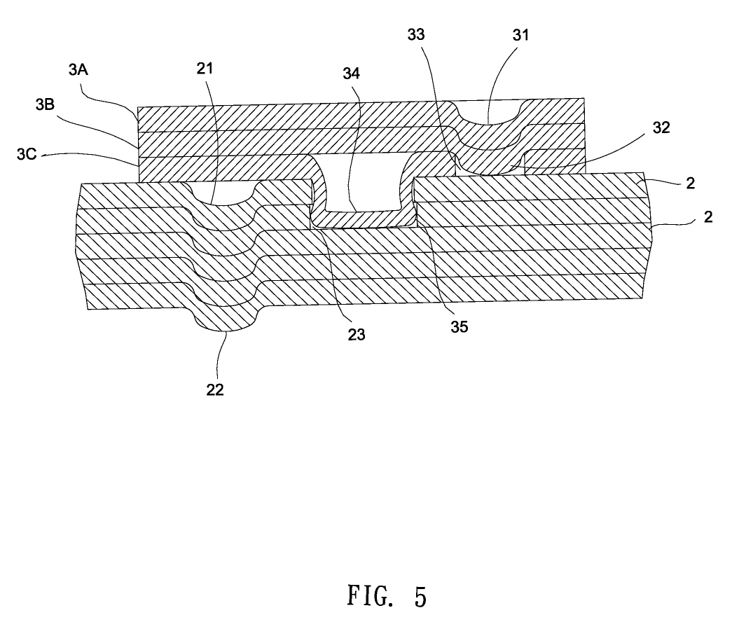

Referring to FIGS. 1 to 6, an armature 1 of an electric motor in accordance with the invention is shown. For simplifying the description of armature, coils wound thereon are not shown. The armature 1 is a hollow cylinder and comprises a plurality of radially projecting laminations (not numbered) having a plurality of T-shaped electrical steel strips 2 packed together as detailed later. The electrical steel strip 2 comprises a center hole (not numbered) on the short part, a plurality of (e.g., two) recesses 21 on a front surface of the short part, and a plurality of (e.g., two) projections 22 on a rear surface of the short part aligned with the recesses 21. That is, the recesses 21 and the projections 22 are formed at one time by punching.

Each of two front most electrical steel strips 2 has an arcuate through hole 23 proximate either side. Also, each of two rearmost electrical steel strips 2 has an arcuate through hole 23 proximate either side. That is, the recesses 21 are disposed between the through holes 23 of the same electrical steel strip 2.

The armature 1 further comprises a plurality of interconnections grouped as a plurality of front and rear interconnection groups 3 having first, second and third interconnections 3A, 3B and 3C of rectangle. Each of the first and second interconnections 3A, 3B comprises two transversely spaced recesses 31 on a front surface and a plurality of (e.g., two) projections 32 on a rear surface aligned with the recesses 31. That is, the recesses 31 and the projections 32 are formed at one time by punching. The third interconnection 3C comprises two transversely spaced through holes 33 proximate center, two arcuate grooves 34 each proximate right or left side on a front surface, and two projections 35 on a rear surface aligned with the grooves 34. That is, the projections 35 and the grooves 34 are formed at one time by punching.

An assembly of the invention will be described in detail below. Inserting the recesses 22 of, for example, a first electrical steel strip 2 into the projections 21 of a second electrical steel strip 2 therebehind by snapping will secure the first and second electrical steel strips 2 together. In such a manner, a complete lamination can be assembled. Next, inserting the projections 32 of the first interconnection 3A into the recesses 31 of the second interconnection 3B and inserting the projections 32 of the second interconnection 3B into the through holes 33 of the third interconnection 3C will assemble an interconnection group 3. Next, inserting the projections 35 of the third interconnection 3C of one interconnection group 3 into, for example, the through holes 23 of two front electrical steel strips 2 of one lamination and the through holes 23 of two front electrical steel strips 2 of an adjacent lamination by snapping will assemble one interconnection group 3 and two adjacent laminations together. In such a manner, a complete armature 10 can be assembled.

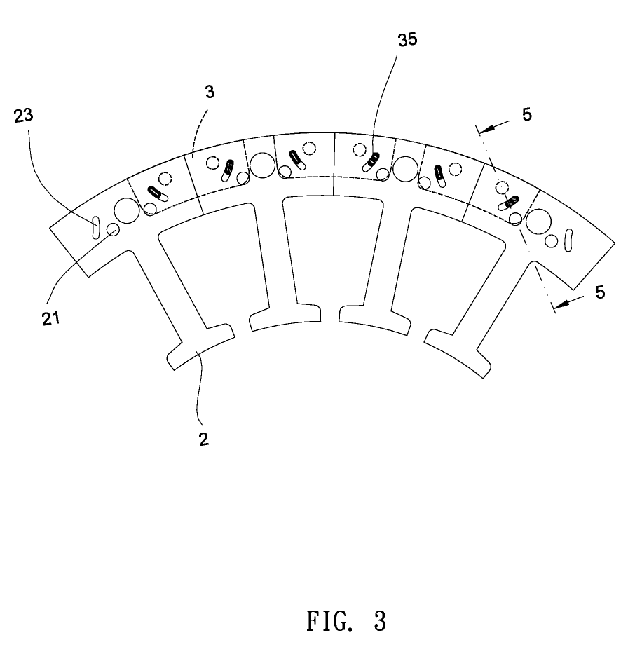

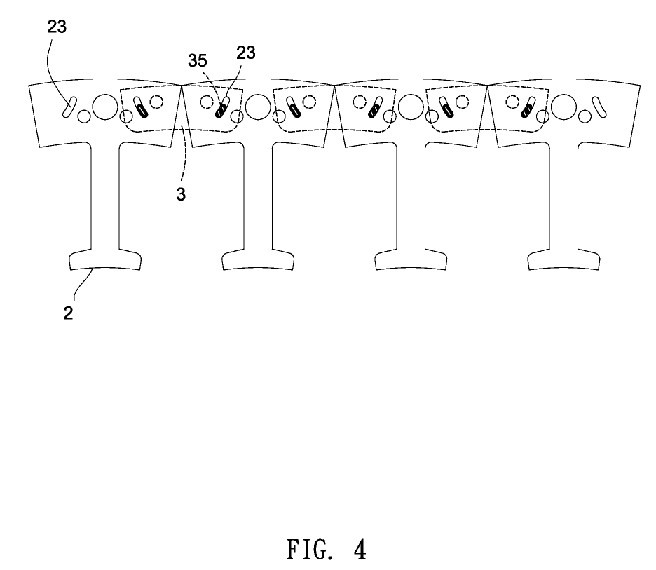

The through holes 23 of, for example, the front most electrical steel strip 2 are slightly smaller than that of the next front most electrical steel strip 2 and the projection 35 of the third interconnection 3C is smaller than the through hole 23 of each of the front most electrical steel strip 2 and the next front most electrical steel strip 2. As such, the projection 35 of the third interconnection 3C snapped into the through holes 23 of the two front most electrical steel strips 2 can be lockingly engaged therewith. Moreover, the projection 35 of the third interconnection 3C is adapted to slide in the through hole 23 such that any two adjacent electrical steel strips 2 can slightly pivot about a joining outer edge therebetween (see FIGS. 3 and 4).

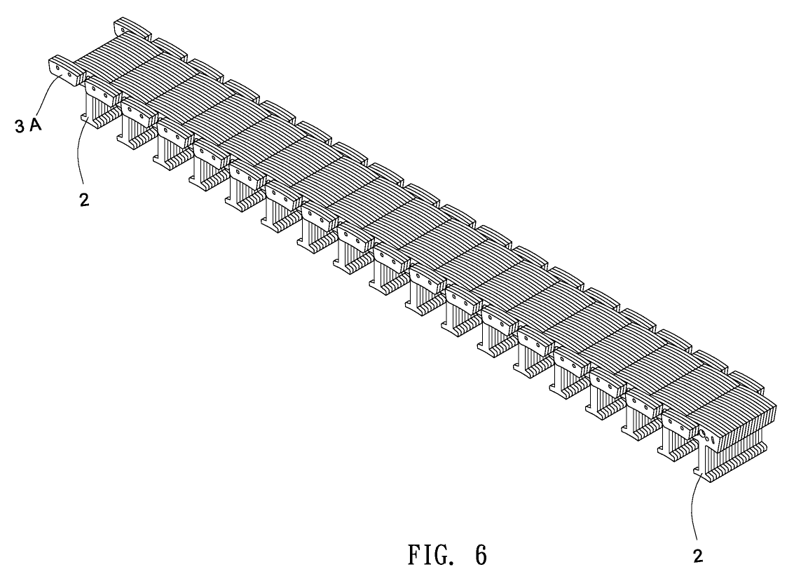

First, the assembled electrical steel strips 2 are unfolded (see FIG. 6). Next, coils (not shown) are wound on the long parts of the electrical steel strips 2. Finally, fold the electrical steel strips 2 to form a complete armature with coils being omitted (see FIG. 1).

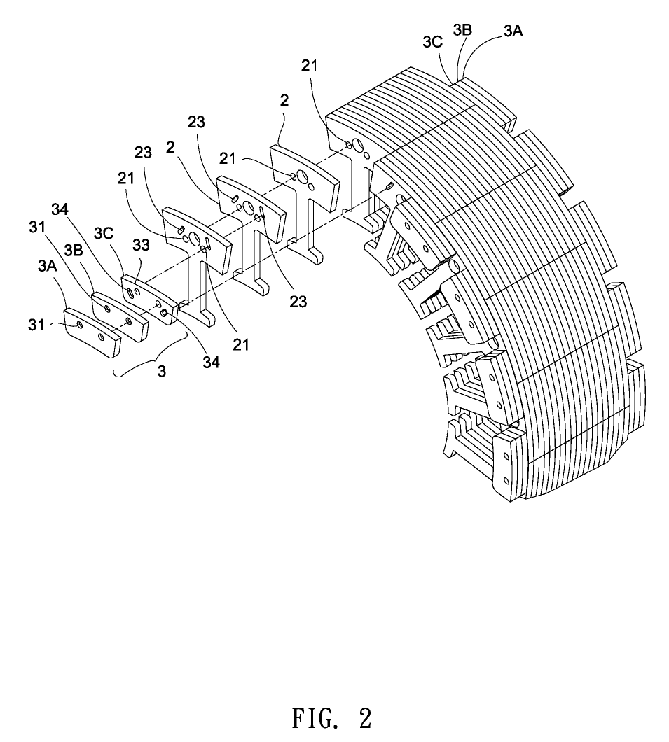

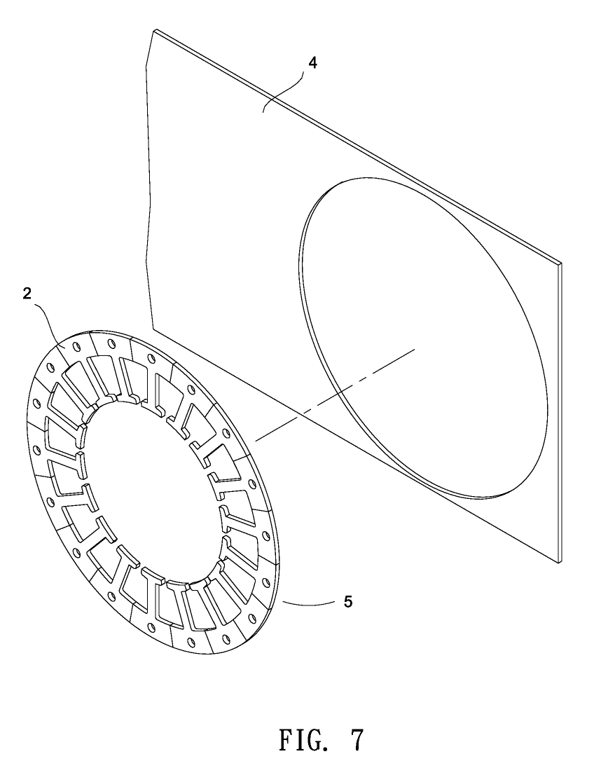

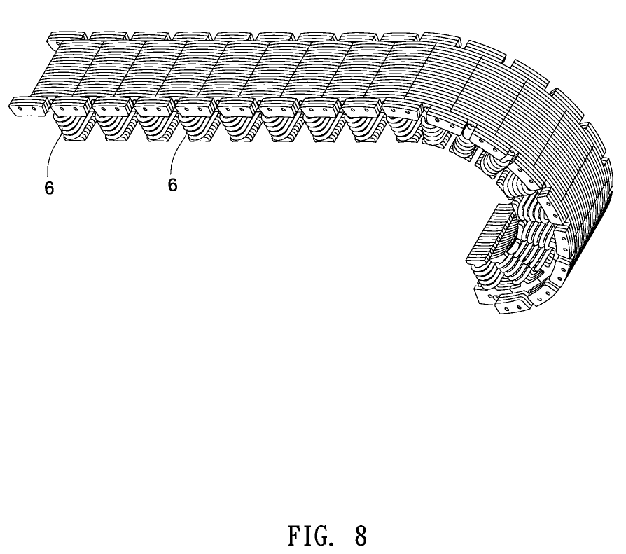

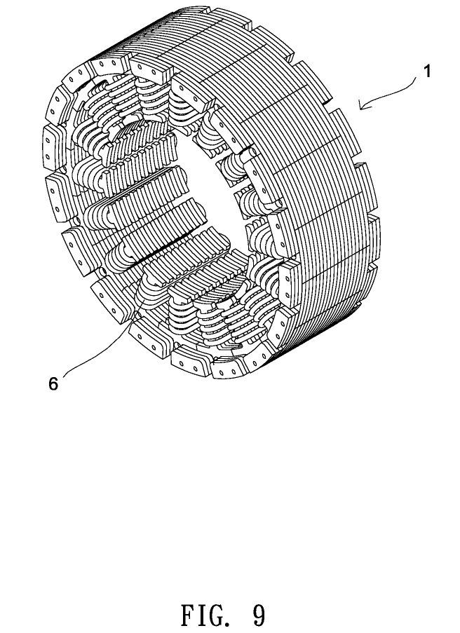

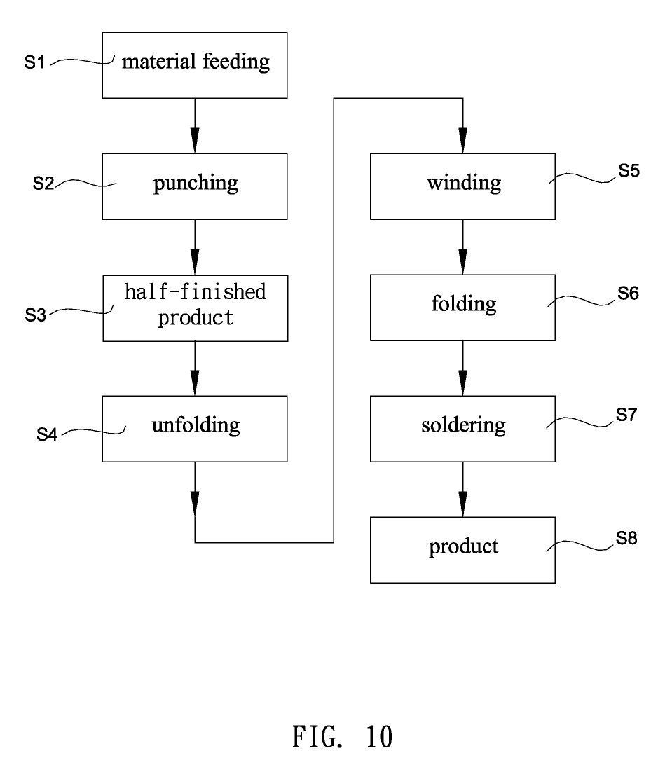

Referring to FIGS. 7 to 10, a process for manufacturing an armature according to the invention is illustrated. First, feed an elongated strip of electrical steel sheet material 4 (step 1). Punch the elongated strip of electrical steel sheet material 4 into a plurality of circular pieces 5 of electrical steel by means of a punch (step 2). Cut the circular pieces 5 of electrical steel into a plurality of individual electrical steel strips and assemble with a plurality of interconnections 3 to produce a half-finished product (step 3) (see FIGS. 2 to 5). Unfold the half-finished product (step 4). Wind copper coils 6 on the long parts of the T-shaped electrical steel strips 2 (step 5) (see FIG. 8). Coil winding on the unfolded electrical steel strips 2 can increase the performance of the armature to be finished by eliminating the conventional winding uneven problem. Also, winding cost can be reduced significantly. Next, fold the electrical steel strips 2 to form a complete hollow cylinder (see FIG. 6). Finally, solder the joining portions of the cylinder to produce the finished armature (steps 7 and 8).

While the invention herein disclosed has been described by means of specific embodiments, numerous modifications and variations could be made thereto by those skilled in the art without departing from the scope and spirit of the invention set forth in the claims.

What is claimed is:

1. An armature of an electric motor, comprising:
a plurality of radially projecting laminations having a plurality of T-shaped electrical steel strips including a plurality of recesses on a front surface of its short part, and a plurality of projections on a rear surface of the short part aligned with the recesses wherein each of the two outermost electrical steel strips further has an arcuate first through hole proximate either side; and
a plurality of front and rear interconnection groups comprising first, second, and third interconnections wherein each of the first and the second interconnections comprises two transversely spaced cavities on a front surface and two protrusions on a rear surface aligned with the cavities, and the third interconnection includes two transversely spaced second through holes, two arcuate grooves each proximate either right or left side on a front surface, and two protuberances on a rear surface aligned with the grooves, whereby:
(a) inserting the recesses of one electrical steel strip into the projections of the other electrical steel strip therebehind will secure the electrical steel strips together and assemble a lamination by repeating the insertion;
(b) inserting the protrusions of the first interconnection into the cavities of the second interconnection and inserting the protrusions of the second interconnection into the second through holes of the third interconnection will assemble an interconnection group;
(c) inserting the protuberances of the third interconnection of one interconnection group into the first through holes of the two outermost electrical steel strips of one lamination and into the first through holes of the two outermost electrical steel strips of an adjacent lamination respectively will assemble one interconnection group and the two adjacent laminations together;
(d) repeating (c) will assemble a first half-finished armature;
(e) winding coils on the first half-finished armature will assemble a second half-finished armature; and
(f) folding the second half-finished armature will assemble the finished armature.

2. The armature of claim 1, wherein the first through holes of the outermost electrical steel strip are smaller than that of the adjacent electrical steel strip and the protuberance of the third interconnection is smaller than the first through hole of each of the outermost electrical steel strip and the adjacent electrical steel strip such that the protuberance of the third interconnection snapped into the first through holes of the two outermost electrical steel strips are lockingly engaged, and the protuberance of the third interconnection is adapted to slide in the first through holes for enabling one electrical steel strip to pivot about the other connected electrical steel strip.

3. The armature of claim 1, wherein the electrical steel strip further comprises a center hole on the short part.

4. A method of manufacturing an armature of an electric motor, comprising the steps of:
(a) feeding an elongated strip of electrical steel sheet material;
(b) punching the elongated strip of electrical steel sheet material into a plurality of circular pieces of electrical steel;
(c) cutting the circular pieces of electrical steel into a plurality of individual T-shaped electrical steel strips;
(d) assembling the electrical steel strips with a plurality of interconnections to produce a first half-finished armature;
(e) unfolding the first half-finished armature;
(f) winding coils on the electrical steel strips;
(g) folding the electrical steel strips to form a second half-finished armature; and
(h) soldering joining portions of the second half-finished armature to produce the finished armature.

5. The method of claim 4, wherein each electrical steel strip comprises a plurality of recesses on a front surface of its short part, and a plurality of projections on a rear surface of the short part aligned with the recesses wherein each of the two outermost electrical steel strips further has an arcuate first through hole proximate either side.

6. The method of claim 5, wherein the electrical steel strip further comprises a center hole on the short part.

7. The method of claim 4, wherein the interconnections are grouped as front and rear interconnection groups comprising first, second, and third interconnections wherein each of the first and the second interconnections comprises two transversely spaced cavities on a front surface and two protrusions on a rear surface aligned with the cavities, and the third interconnection includes two transversely spaced second through holes, two arcuate grooves each proximate either right or left side on a front surface, and two protuberances on a rear surface aligned with the grooves.
